(19) United States
(12) Patent Application Publication
(10) Pub. No.: US 2002/0068670 A1
(43) Pub. Date: Jun. 6, 2002

(54) Article storing bag and manufacturing method thereof

(76) Inventors: Nobuyoshi Kiyohara, Tokyo (JP); Fusazou Maruyama, Tokyo (JP); Junichirou Yano, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 09/966,752

(22) Filed: Oct. 1, 2001

(30) Foreign Application Priority Data
Dec. 4, 2000 (JP) 2000-368417

(51) Int. Cl. B65D 33/04; B65D 85/00; B31B 1/88

(52) U.S. Cl. 493/320; 206/720; 383/106

(57) ABSTRACT

An object of the present invention is to provide an article storing bag and manufacturing method thereof that can reduce effects of static electricity, simplify work of storing an article, and eliminate discrepancy between the stored article and the article information displayed on the article storing bag.

The present invention provides an article storing bag that is formed with an opening 10a for insertion of an article by folding transparent resin film 11 double, and by fusing a peripheral portion of the folded resin film while leaving a part of the peripheral portion non-fused, wherein: a first base coat 12 of black ink is printed on one surface of the article storing bag; first information 13 is recorded with red ink on said first base coat; a second base coat 14 of white ink is printed on the other surface of the article storing bag; second information 15 is recorded on said second base coat; and said white ink forming said second base coat is an ink having a good conductivity.

### BACKGROUND OF THE INVENTION

1. Field of the Invention

The present invention relates to an article storing bag for storing a small part or the like and a manufacturing method thereof, and, in particular, to an article storing bag attached with information on the stored article and a manufacturing method thereof.

2. Related Art Statement

Conventionally, when small-size parts such as repairing parts or renewal parts are stocked, each part is stored in an article storing bag.

Here, when an article is stocked in an article storing bag in this way, part information such as the kind and manufacturing date of the stored article is attached to that article storing bag, for management of the article.

And, conventionally, as a method of attaching the mentioned part information to an article storing bag, is employed a method in which a label 3 printed with part information 2 is stuck to the surface of the article storing bag 1, as shown in FIG. 5 (see, for example, Japanese Unexamined Patent Laid-Open No. 6-214505).

On the other hand, the mentioned label 3 is prepared using a printing apparatus as shown in FIGS. 6 and 7, for example.

This printing apparatus generally comprises: a feed roll 5, i.e., a winding of long mounting paper 4 on which many labels 3 are temporarily adhered at given intervals; a printer 6 for printing on the mentioned mounting paper drawn from the feed roll 5; and a wind-up roll 7 for winding the mentioned mounting paper 4 together with the printed labels 3.

Here, the mentioned labels 3 are printed with part information by the printer 6, and wound by the mentioned wind-up roll 7.

Thus-prepared label 3 is peeled from the mounting paper 4 wound on the mentioned wind-up roll 7, and stuck on an article storing bag 1 that stores a part corresponding to the printed part information, as shown in FIG. 5.

In many cases, the above-described article storing bag 1 is formed of transparent synthetic resin, and has a very low conductivity. Thus, it is possible that, when friction or the like generates static electricity in the article storing bag 1, the static electricity is retained in the article storing bag and affects the stored part, lowering the yield of parts.

Further, the label 3 is manually stuck to the article storing bag 1, and thus, the sticking work is troublesome. And, there is also a problem that a mistake in sticking of the label 3 or misregistration of the sticking position tends to occur.

Further, usually, after peeling the labels 3, the mounting paper 4 is not reused and is discarded, increasing the costs and trash.

The present invention has been made taking the above-described conventional problems into consideration. And, an object of the present invention is to provide an article storing bag and its manufacturing method that can lower the effects of the static electricity, simplify storing of an article, and eliminate discrepancy between the stored article and the article information displayed on the article storing bag.

### SUMMARY OF THE INVENTION

To attain the above-described object, Claim 1 of the present invention provides an article storing bag, which is formed with an opening for insertion of an article by folding transparent resin film double, and by fusing a peripheral portion of the folded resin film while leaving a part of the peripheral portion non-fused, characterized in that: a first base coat of black ink is printed on one surface of the article storing bag; first information is recorded with red ink on said first base coat; a second base coat of white ink is printed on the other surface of the article storing bag; second information is recorded on said second base coat; and said white ink forming said second base coat is an ink having a good conductivity.

The present invention of Claim 2 provides the article storing bag, wherein: the conductivity of said white ink of Claim 1 is increased by mixing fine powder of aluminum oxide.

The present invention of Claim 3 provides the article storing bag according to Claim 1 or 2, wherein: conductivity of said resin film is increased by mixing sodium carbonate or calcium carbonate.

The present invention of Claim 4 provides a method of manufacturing an article storing bag, comprising steps of: forming first rectangle-shaped base coats of black ink on one side of long resin film with respect to a center defined by an intermediate portion of said resin film in width direction, and second rectangle-shaped base coats of white ink on the other side of said resin film, said first base coats and said second base coats being formed at given intervals all over total length in length direction of said resin film; forming mark lines of black ink between said first base coats, being spaced from said first base coats, respectively; folding said resin film double in said intermediate portion in the width direction, such that said first base coat and said second base coat become exterior; fusing, thereafter, said resin film at a superposed peripheral portion of said resin film; fusing said resin film at portions where said mark lines are formed, all over length of said resin film in the width direction; providing perforations in non-fused portions of said resin film, along said portions where said mark lines are formed; winding said resin film to form an initial roll; printing on said first and second base coats while drawing said resin film from said initial roll; and cutting off the printed resin film at said perforations, to obtain article storing bags.

### BRIEF DESCRIPTION OF THE DRAWINGS

FIG. 1 is a view showing an embodiment of the present invention, and illustrating front and back of an article storing bag;

FIG. 2 is a view showing an embodiment of the present invention, as a development of the article storing bag;

FIG. 3 is a view showing an embodiment of the present invention, as a schematic plan view illustrating a manufacturing apparatus for the article storing bag;

FIG. 4 is a view showing an embodiment of the present invention, as a perspective view showing a main part of the manufacturing apparatus for the article storing bag;

FIG. 5 is a perspective view illustrating work of attaching article information in the case of a conventional article storing bag;

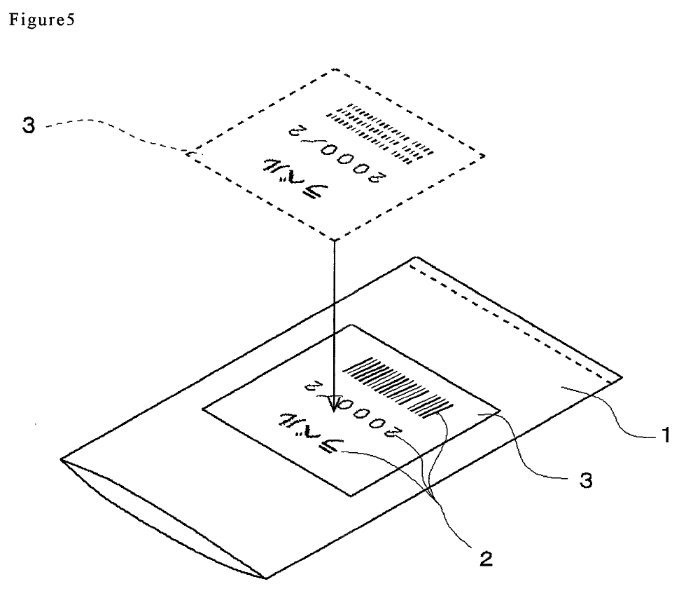

FIG. 6 is a view for illustrating work of attaching article information in the case of conventional article storing bag, as a schematic side view showing a label printing apparatus; and

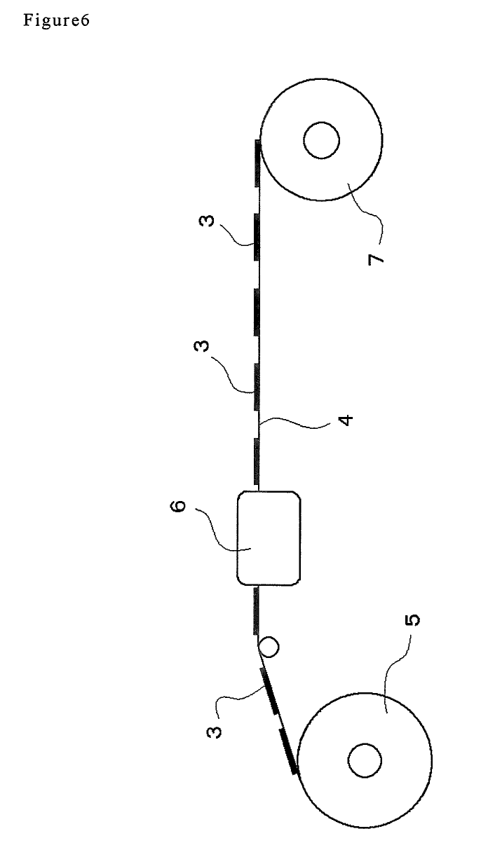

FIG. 7 is a view for illustrating work of attaching article information in the case of conventional article storing bag, as a schematic plan view showing the label printing apparatus.

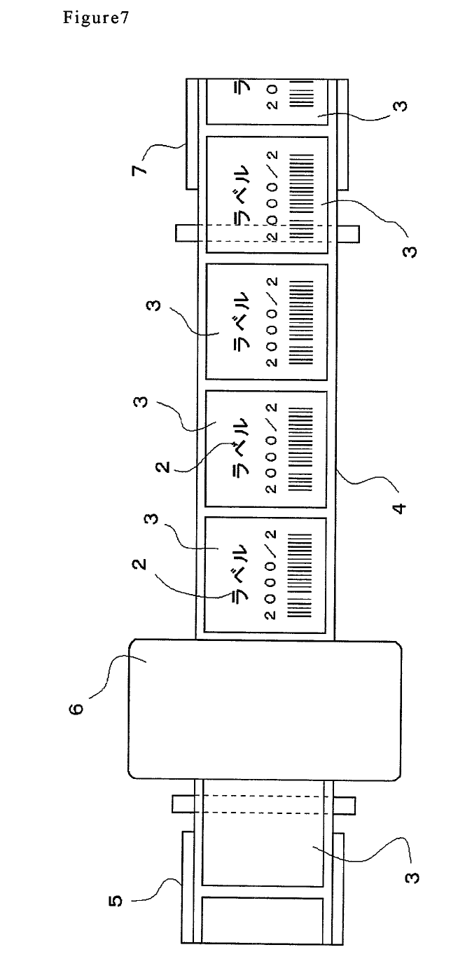

### DETAILED DESCRIPTION

In the following, an embodiment of the present invention will be described referring to the drawings.

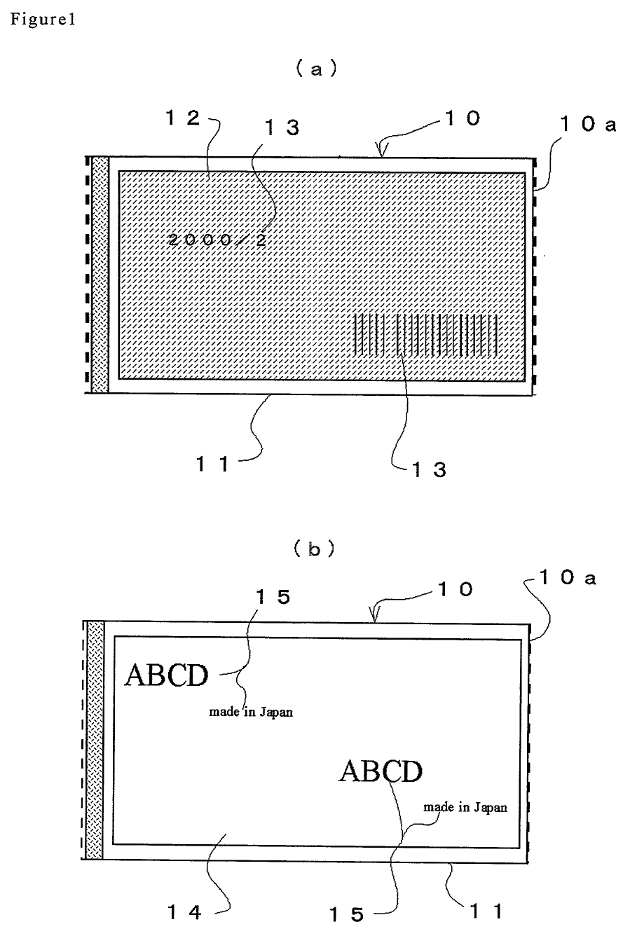

In FIG. 1, the reference numeral 10 refers to an article storing bag according to the present invention. This article storing bag 10 is formed with an opening 10a for inserting an article, by folding transparent resin film 11 double, and by fusing its peripheral portion, leaving a part of the peripheral portion non-fused. As shown in FIG. 1(a), one surface of the bag is printed with a first base coat 12 of black ink, and first information 13 is recorded with red ink on the first base coat. The other surface is printed with a second base coat 14 of white ink, and second information 15 is recorded on the second base coat 14. The white ink, which forms the second base coat 14, is an ink of a good conductivity.

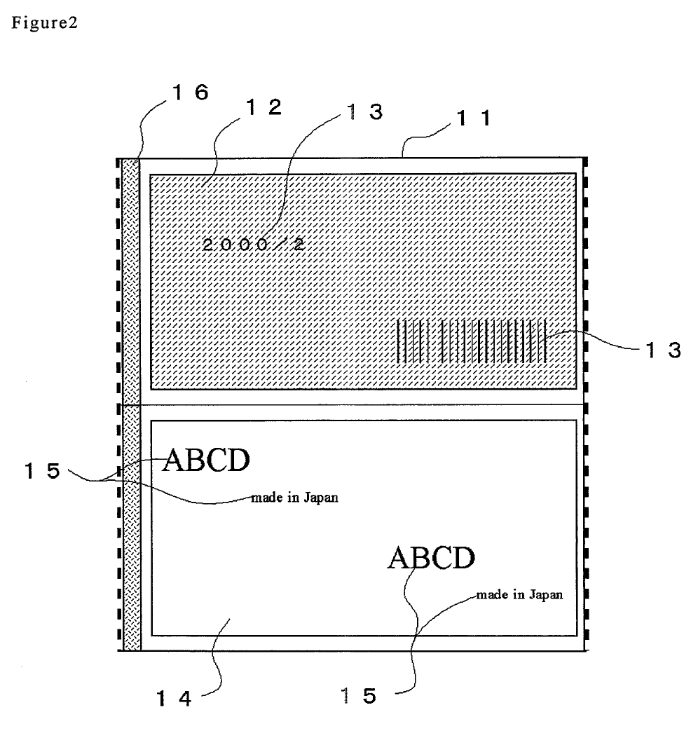

In detail, the mentioned resin film 11 is made of polyethylene, and, as shown in FIG. 2, is formed into a bag shape by folding rectangle-shaped resin film 11 double in the center line, i.e., the central portion in the width direction and by heat-sealing the peripheral portion except for a side where the above-mentioned opening 10a is provided. When the film has been shaped into the bag, the above-mentioned first base coat 12 and the second base coat 14 are located on the exterior of the bag.

Further, sodium carbonate or calcium carbonate is mixed into the above-mentioned resin film 11 to increase its conductivity.

Further, fine powder of aluminum oxide is mixed into the above-mentioned white ink to increase its conductivity.

Further, an ordinary printer is used to directly print the first information 13 and the second information 15 on the above-mentioned base coats 12, 14, respectively.

An article corresponding to the above-mentioned first information 13 or the second information 15 is inserted through the opening 10a of thus-formed article storing bag 10 according to the present invention, and thereafter, the mentioned opening 10a is fastened by adhesive tape or closed by heat sealing, to store the article. The bag is stocked in this state.

In such article storing work, since the article storing bag 10 is already attached with the information (the first information 13 or the second information 15) corresponding to an article to be stored, a worker needs only to insert an article corresponding to the information into the article storing bag 10, and thus it simplifies the work.

Further, the worker can insert an article while confirming the above-mentioned first information 13 or the second information 15, and thus, he can avoid inserting a wrong article.

Further, the above-mentioned first information 13 or the second information 15 to be attached is directly printed on the article storing bag 10 by the printer, and accordingly, its misregistration does not occur. Thus, the above-mentioned first or second information 13, 15 is attached to the equal position, and this facilitates confirmation of the article information, in the state of stock.

On the other hand, since the above-mentioned second base coat 14 has good conductivity, even when static electricity is generated in the article storing bag 10, the static electricity is discharged through the above-mentioned second base coat 14.

As a result, effects of the static electricity on the stored article can be prevented.

Further, in the present embodiment, the conductivity of the above-mentioned resin film 11 is increased. Accordingly, even when static electricity is generated inside the resin film 11, the static electricity is discharged outside through the above-mentioned resin film 11 and the second base coat 14. Thus, the above-mentioned effects of the static electricity can be more effectively prevented.

Next, a method of manufacturing the above-mentioned article storing bag 10 will be described.

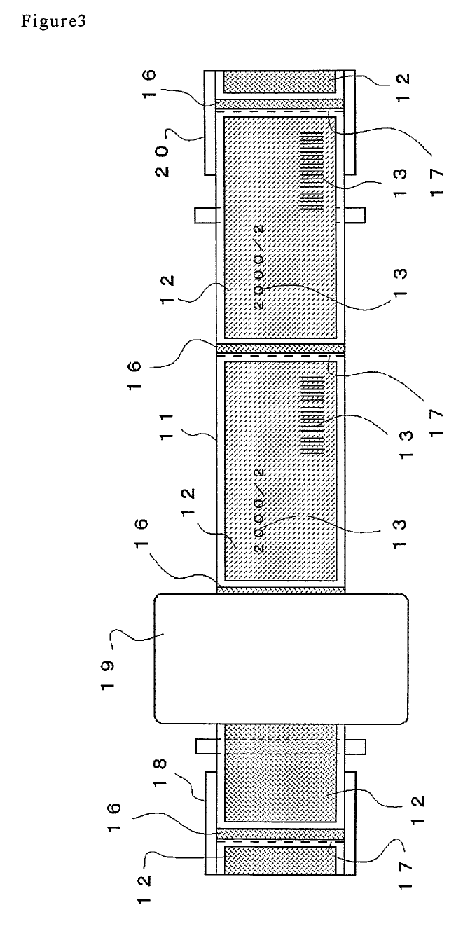

First, as shown in FIG. 2, one side of long resin film 11 with respect to its center, i.e., the intermediate portion in the width direction, is formed with the rectangle-shaped first base coat 12 of black ink, and the other side is formed with the rectangle-shaped second base coat 14 of white ink. These first and second base coats 12 and 14 are formed at given intervals all over the total length in the length direction of the above-mentioned resin film 11. At the same time, between the above-mentioned first base coats 12, are formed respective mark lines 16 (see FIG. 3) of black ink, being spaced from those first base coats 12. Then, the above-mentioned resin film 11 is folded double in the intermediate portion in its width direction, such that the above-mentioned first and second base coats 12 and 14 become exterior. Thereafter, the resin film 11 is fused at the superposed peripheral portion, and then, the mentioned resin film 11 is fused at the portions where the above-mentioned mark lines 16 are formed, all over its length in the width direction. At the same time, perforations 17 are provided in non-fused portions of the above-mentioned resin film 11 along the above-mentioned mark lines 16. This resin film 11 is wound to form an initial roll 18.

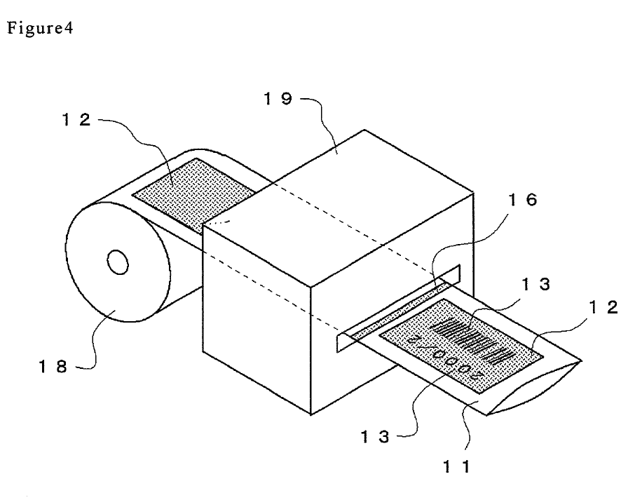

Then, as shown in FIGS. 3 and 4, the above-mentioned resin film 11 is drawn from the above-mentioned initial roll 18, passed through the printer 19, and fixed at its leading edge to the wind-up roll 20.

This printer 19 has a function of two-side simultaneous printing.

By this function, when the above-mentioned printer 19 is driven while the above-mentioned resin film 11 is successively wound into the wind-up roll 20, the first information 13 and the second information 15 are simultaneously printed on the above-mentioned first and second base coats 12, 14 formed on the front and the back of the above-mentioned resin film 11, respectively.

Here, the above-mentioned printer 19 detects the mark lines 16 provided in the above-mentioned continuous resin film 11, to detect the positions of the above-mentioned first and second base coats 12 and 14. Based on this detection result, print positions for the above-mentioned first information 13 and second information 15 are decided.

Further, the above-mentioned first information 13 and second information 15 are inputted through a separately-provided input device. When the number of prints is inputted at the same time, different kinds of information can be successively printed in respective required numbers.

Accordingly, effective and reliable storing of a small amount and a large variety of articles can be realized.

The above-mentioned resin film 11, which has been subjected to the printing as described above, is wound into the wind-up roll 20, in a continuous state. At the time of use, the film is cut off along the above-mentioned perforations 17, to be used one by one.

In the above-described embodiment, the shapes, sizes, etc. of the components are explanatory, and may be variously changed according to a shape and the like of an article to be stored.

As described above, according to the present invention, the second base coat having good conductivity is formed on the article storing bag. As a result, static electricity in the article storing bag can be discharged promptly, and a stored article can be protected satisfactorily.

Further, the resin film forming the article storing bag has good conductivity in itself, and thereby, effects by static electricity can be further suppressed.

On the other hand, since the information on an article to be stored is already attached, work for storing the article is only an operation of inserting the article into the article storing bag. Thus, the work can be simplified. In addition, mounting paper required for using labels become unnecessary, and thus quantity of trash can be reduced. Further, misregistration of the article information attached to the article storing bag can be eliminated and the information can be easily confirmed.

### DESCRIPTION OF REFERENCE NUMERALS

1 article storing bag

2 part information

3 label

4 mounting paper

5 feed roll

6 printer

7 wind-up roll

10 article storing bag

11a opening

11 resin film

12 first base coat

13 first information

14 second base coat

15 second information

16 mark lines

17 perforations

18 initial roll

19 printer

20 wind-up roll

1. An article storing bag, which is formed with an opening for insertion of an article by folding transparent resin film double, and by fusing a peripheral portion of the folded resin film while leaving a part of the peripheral portion non-fused, wherein:
a first base coat of black ink is printed on one surface of the article storing bag;
first information is recorded with red ink on said first base coat;
a second base coat of white ink is printed on the other surface of the article storing bag;
second information is recorded on said second base coat; and
said white ink forming said second base coat is an ink having a good conductivity.

2. The article storing bag according to claim 1, wherein:
the conductivity of said white ink is increased by mixing fine powder of aluminum oxide.

3. The article storing bag according to claim 1 or 2, wherein:
conductivity of said resin film is increased by mixing sodium carbonate or calcium carbonate.

4. A method of manufacturing an article storing bag, comprising steps of:
forming first rectangle-shaped base coats of black ink on one side of long resin film with respect to a center defined by an intermediate portion of said resin film in width direction, and second rectangle-shaped base coats of white ink on the other side of said resin film, said first base coats and said second base coats being formed at given intervals all over total length in length direction of said resin film;
forming mark lines of black ink between said first base coats, being spaced from said first base coats, respectively;
folding said resin film double in said intermediate portion in the width direction, such that said first base coat and said second base coat become exterior;
fusing, thereafter, said resin film at a superposed peripheral portion of said resin film;
fusing said resin film at portions where said mark lines are formed, all over length of said resin film in the width direction;
providing perforations in non-fused portions of said resin film, along said portions where said mark lines are formed;
winding said resin film to form an initial roll;
printing on said first and second base coats while drawing said resin film from said initial roll; and
cutting off the printed resin film at said perforations, to obtain article storing bags.
